(19) United States
(12) Patent Application Publication
(10) Pub. No.: US 2014/0278765 A1
(43) Pub. Date: Sep. 18, 2014

(54) Trend Analysis using Network-Connected Touch-Screen Generated Signals

(71) Applicant: Zuse, Inc., New York, NY (US)

(72) Inventor: Gordon Chiu, Chatham, NJ (US)

(73) Assignee: Zuse, Inc., New York, NY (US)

(21) Appl. No.: 14/217,642

(22) Filed: Mar. 18, 2014

Related U.S. Application Data
(60) Provisional application No. 61/802,813, filed on Mar. 18, 2013.

(51) Int. Cl. G06Q 30/02

(52) U.S. Cl. CPC G06Q 30/0201
USPC 705/7.29

(57) ABSTRACT

A method of identifying and analyzing a trend is disclosed. A signal created on a network-connected touch-screen by actively filtering content is received by a programmed data processor. The processor creates a signal-vector by mapping the signal to two or more vector-dimensions, one being a location of origination of the signal. This is repeated for more signals. A trend is identified as a cluster of signal-vectors having a size that exceeds a predetermined threshold. One use of identifying and analyzing trends is to then influence the trend. Advertising is one form of influencing a trend.

### CLAIM OF PRIORITY

This application claims the priority of U.S. Ser. No. 61/802,813 filed on Mar. 18, 2013, the contents of which are fully incorporated herein by reference.

### FIELD OF THE INVENTION

The invention relates to systems and methods of identifying and analyzing trends on networks such as social networks, and more particularly to the use of real-time touch screen related signals and metrics for use in identifying and influencing trends including identifying and valuing trends that may provide on-line advertising opportunities.

### BACKGROUND OF THE INVENTION

Real-time touch screens are rapidly becoming the preferred user interface for interacting with electronic devices, especially for browsing information and entertainment sites on the Internet. This shift from keyboard to real-time touch screen may have far reaching consequences. In particular, the use of real-time touch screens may adversely impact online advertising as the most effective online advertising currently uses matches to search keywords to value and to target advertising content. With touch-screen powered user interfaces, searches rely more on direct interaction with images and less on text input, providing challenges for keyword based advertising, and opening up opportunities for identifying and valuing advertising opportunities based on metrics that are unique to real-time touch screens.

On a real-time touch screen, content may, for instance, be transferred from one location to another by means of touch gestures. Such a transfer may, for example, be made to share information, or it may be made as an input to a search engine. For instance, transferring an image of a shoe may result in a search for sellers of that type of shoe. To initiate such a search, a user may make contact with the image of the shoe as it appears on one part of the display screen, where it may, for instance, be a frame of a TV show, and then make contact with another part of the display screen that currently represents the search site, thereby effecting the transfer, or copying, of the image from the original location to the search engine. No text need be entered in choosing the image or in transferring it, making keyword association problematic. There is, however, important information available to the advertiser in such a gesture transfer such as, but not limited to, the location of the user, the URL's of the sites involved, the meta-data attached to the transfer and the time and date of the transfer.

On a real-time touch screen there are also additional parameters that may be captured that may be of use in identifying and valuing advertising opportunities. These additional parameters include, but are not limited to, the nature of the transfer gesture, including factors such as the speed of the gesture, the length of the gesture, the direction of the gesture or some combination thereof. These additional parameters may, for instance, be indicative of the meaning, or of the emotions, associated with the transfer or the search and may, for instance, be used as a basis in creating virtual maps or networks that enable the visualization of the users' statistics. In one embodiment of the present invention, certain aspects of a data transfer such as, but not limited to, the URLs, the time, the content meta-data or some combination thereof, may be captured and used to create categories of transactions. These transaction categories may, for instance, be recorded mathematically as vectors. In addition, the present invention may capture the further aspects of real-time touch screen interaction such as, but not limited to, the nature, the speed, the length, the direction or other aspects of the gesture. These additional factors, or parameters, may then be expressed mathematically as a tensor of weighting factors that may, for instance, be combined with the vector to produce a measure of the value of the opportunity, as described in greater detail below.

### DESCRIPTION OF THE RELATED ART

The relevant prior art includes:

US Patent Application 20100217657 published by R. Gazdzinski on Aug. 26, 2010 entitled “Adaptive Information Presentation Apparatus and Methods” that describes an adaptive information presentation apparatus and associated methods. In one embodiment, the apparatus comprises a computer readable medium having at least one computer program disposed thereon, the at least one program being configured to adaptively present (e.g., display or play out via an audio system) information that is related or in response to inputs provided via an input device such as a for example touch-screen display device. In one variant, the at least one program analyzes user input to determine a context of the input, and selects advertising related to the context for presentation to the user.

US Patent Application 20110050394 published by K. Zhang on Mar. 3, 2011 entitled “Systems and Methods for Pressure-Based Authentication of an Input on a Touch Screen” that describes systems and methods for authenticating an input on a touch screen. A method comprises obtaining one or more pressure metrics for an input by a user on a touch screen that is being proffered as that of a known user. Each pressure metric corresponds to a pressure applied to the touch screen by the user at a respective impression location of the input. The method further comprises authenticating the user as the known user based at least in part on the one or more pressure metrics.

U.S. Pat. No. 8,279,039 issued to Thorn on Oct. 2, 2012 entitled “Using touches to transfer information to a device” that describes a device receiving a signal that includes information about a touch pattern on a surface of the tag, identifying the touch pattern based on the received signal, validating tag-specific information in the received signal by comparing the identified touch pattern and information that is stored prior to receiving the signal, and performing an action that is specified by the tag-specific information if the tag-specific information is validated.

Various implements are known in the art, but fail to address all of the problems solved by the invention described herein. One embodiment of this invention is illustrated in the accompanying drawings and will be described in more detail herein below.

### SUMMARY OF THE INVENTION

A method of identifying, analyzing and influencing trends using network-connected touch-screen generated signals is disclosed that may, for instance, be used to identify and exploit trends on networks such as, but not limited to, social networks.

When a user of a network-connected touch-screen device actively filters content on that device, i.e., the user interacts with content being displayed using a gesture such as, but not limited to, touching, tapping, swiping or some combination thereof, a signal is generated that may be received, or gathered, by a programmed data-processor connected to the same network.

The data-processor may then create a signal-vector by mapping the signal to two or more vector-dimensions, one of which may be a location of origination of the signal.

This process may be repeated for a number of signals and one or more trends may be identified. A trend may, for instance, be defined as a cluster of signal-vectors having a size that may exceed some predetermined threshold.

One use of identifying and analyzing trends may be to influence the trend. This may, for instance, be accomplished by sending signals targeted to the location in vector space of the trend. The targeted material may be intended to dampen out the trend, to maintain it or to grow it.

One form of influencing the trend or the users generating the signals constituting the trend is advertising.

In a further preferred embodiment of the present invention, a user may have a graphic user interface that may have a touch-screen and an electronic display. The electronic display may, for instance, simultaneously display content obtained from a number of different websites. This content may be displayed as tiles that may, for instance, be arrays of pixels on the electronic display. The display may be controlled, at least in part, by an operating system that may be programmed to respond to user gesture input and for instance, transfer content from one tile to another when activated by an appropriate touch gesture that may be indicative of a transfer path. The present invention may be used to capture such a gesture transaction on a real-time touch screen enabled user interface as a particular type of signal. Additional data that may be used to create a signal vector may, for instance, be obtained from meta-data associated with the content element, or by some method such as, but not limited to, pattern recognition, or some combination thereof.

The system may then deliver an advertising element that may have been previously associated with the subject type detected in the captured transaction. The advertising element may, for instance, be delivered to one of the tiles involved in the transfer, or to another tile on the display.

In a further preferred embodiment of the invention, capturing a signal from a transaction may also include recording attributes associated with the transaction such as, but not limited to, a web-site type for each tile and the start and end points of the touch gesture. This may then be used in creating a signal vector.

Capturing a transaction may further include recording other attributes of the transfer gesture such as, but not limited to, recording a length and a velocity of the touch gesture. These other attributes may then be arranged mathematically as a weighting tensor. This weighting tensor may then be combined with the category vector using standard tensor algebra methods to obtain a transaction value. This transaction value may, for instance, be used to define, to value or to auction advertising-opportunities associated with that category vector.

Other attributes or parameters include, but are not limited to, the length of time or duration that the user spends on a particular object, or stays within a certain subject or category or some combination thereof. These may, for instance, be used to create a “heat map” by having the visual intensity of a visual map or network be related to the length of time by, for instance a projected linear relationship. Such a heat map may allow further analysis for purposes such as, but not limited to, trend definition.

Another parameter of use may for instance be the ratio of repeat visits to an element of content as a function of how often that element is changed. A content element, such as a piece of news, that is only changed at a low frequency, but which attracts a large number of repeat visits or accesses may be recorded as a high referencing score. A high referencing score may mean that there is a large chance that the news element may be referenced by the user, and therefore there is a large chance of a new signal being generated that may be considered as a derivative score of the original signal.

Therefore, the present invention succeeds in conferring the following, and others not mentioned, desirable and useful benefits and objectives.

It is an object of the present invention to provide a means of identifying trends from signals generated by users interacting with network-connected touch-screen devices.

It is another object of the present invention to provide a means of influencing identified trends.

It is a further object of the present invention to provide a means of targeting advertising opportunities without using keywords entered by a user.

It is another object of the present invention to provide a system and method for capturing data associated with users interactions with a real-time touch screen interface, and to use this data to define categories of user interaction.

Yet another object of the present invention is to provide a means of weighting the importance of user/touch-screen interactions by recording further attributes unique to real-time touch screen interactions.

Still another object of the present invention is to provide a method of valuing real-time touch screen interactions for the purpose of identifying, valuing and selling online advertising opportunities.

### BRIEF DESCRIPTION OF THE DRAWINGS

FIG. 1 shows a schematic flow diagram of a method of influencing a trend.

FIG. 2 shows a graphic representation of signal-vector and the identification of a trend as a cluster of signal-vectors.

FIG. 3 shows a schematic of a touch-screen interface and associated metrics that may be used for identifying and valuing online advertising opportunities.

FIG. 4 shows a schematic of a touch-screen operated interface in accordance with the present invention.

FIG. 5 shows a schematic of a graphic display of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

FIG. 1 shows a schematic flow diagram of a method of analyzing and influencing a trend.

The trend may, for instance, be identified by capturing, or receiving signals generated by users interacting with, or filtering, content or information. Those signals may then be mapped into signal-vectors. Clusters of signal vectors may then be identified, or designated as trends. These trends may then be influenced by delivering appropriate content to signal generators located within the trend.

This process is illustrated in FIG. 1.

In Step 1001: Receive Signal Generated by Content Filtering, signals are received by the agent wanting to influence a trend. The signals may, for instance, be created on a network-connected touch-screen device such as, but not limited to, to smartphone, a tablet, a lap-top computer or some combination thereof. The signals may, for instance, be representative of the active filtering of content by a user. The content may, for instance, be related to an event, a person or a product, or some combination thereof. Filtering the content may, for instance, involve a user interacting with the content by a touch interaction with the screen. The touch-screen interactions that may generate a signal include actions such as, but not limited to, using the real-time touch screen to select a channel, deselect a channel, increase volume, forward or share content, comment on content or some combination thereof.

In Step 1002: Map Signal to Vector-Dimensions to Create Signal-Vector, the agent who has received the signals may then use them to create signal vectors. This may, for instance, be accomplished using predefined vector-dimensions such as, but not limited to, origination location of the signal, occurrence time, a filter category or some combination thereof.

The origination location may, for instance, be a geo-locator such as, but not limited to, a GPS coordinate, a post code, a phone-district or some combination thereof, or it may be a cyber-locator such as, but not limited to, a URL.

The filter category may, for instance, be an event, a person, a product or some combination thereof. The filter category may, for instance, be obtained in part by known audio-visual content being generated from specific sources that may be available from meta-data associated with the content being interacted with.

In Step 1003: Repeat: the agent loops back to step 1001 and repeats the process of receiving generated by active filtering of content on network connected devices having real-time touch screens.

Step 1004: Identify Trend as Cluster of Signal-Vectors, once enough signal-vectors have been generated so that statistically meaningful results may be obtained, the signal-vectors may be analyzed to identify trends. These trends may, for instance, be represented by clusters of signal-vectors, i.e., by groups of signal-vectors that are within a given vector-dimension volume. Clustering is well-known and widely used in the art of psychometrics, and there are a variety of well-known methods of accomplishing cluster identification once signal-vectors have been defined and collected. The trends may be analyzed further using psychometric technics to produce predictive patterns that may provide heat-maps of the tends. These heat-maps may, for instance, constitute a real-time psychometric measurement of attitudes of signal producers towards the observed trends.

In Step 1005: Influence Trend by Delivering Influence-Module to Signal-Generator within Trend: having identified a suitable cluster, that may, for instance, have certain values of particular vector-dimensions, and may have a number of signal-vectors above a predetermined threshold, the agent may attempt to influence that cluster. Influencing the cluster may, for instance, be accomplished by delivering an influence module to one or more users who have generated signals that are within the cluster. This may be done by delivering the influence module to an origination locator of a signal generator. The influence module may be matched to the available origination locators, such as, but not limited to, sending a video clip to a URL, an audio clip to a smartphone, or some combination thereof. The influence module may, for instance, be a message such as, but not limited to, an advertisement for a product or service, campaign message on behalf of a politician, a public service announcement, or some combination thereof. The influence module may also be an audio-visual message sent to either strengthen the trend or to reduce the trend.

FIG. 2 shows a graphic representation of signal-vector and the identification of a trend as a cluster of signal-vectors.

In the two-dimensional plot of FIG. 2, there are only two vector-dimensions 144 shown. The signal-vectors 139 are plotted in the two-dimension shape. A cluster of signal-vectors 119 may be identified as a trend that may, for instance, be related to an event, a person, a product, a topic, or some combination thereof.

The trend identified by cluster of signal-vectors 119 may be followed over time so that it may be analyzed by, for instance, associating a trend-velocity with the trend. The trend velocity may, for instance, be defined as a rate of change of the cluster size of the trend as a function of time.

In further trend analysis, a trend acceleration may also or instead be associated with the trend, where the trend acceleration may be a rate of change of the trend velocity with time.

FIG. 3 shows a schematic of a touch-screen interface that may be used to actively filter content and so produced signals that may be used for identifying trends, and for valuing opportunities to influence those trends, including, but not limited to, online advertising opportunities.

In a preferred embodiment, a method of influencing trends, or advertising using signal-vectors that may be derived from signals generated when filtering content on a network connected real-time touch screen may include a touch-screen 110 and a graphic user interface 105 that may be displayed on an electronic display 115. The graphic user interface 105 may include one or more tiles 120 that may each be a representation of content 125 from a specific source 130.

The electronic display 115 may, for instance, be controlled, in part, by an operating system 135 (shown in FIG. 4) programmed to transfer a content element 140 from a first tile 145 in which the content is currently displayed to a second tile 150 in response to a user action. This content transfer may, for instance, occur when initiated, or activated to do so, by an appropriate touch gesture 160. The appropriate touch gesture 160 may, for instance, be indicative of a transfer path 155 between the first and second tiles. The appropriate touch gesture 160 may, for instance, also include a user contact 165 with a start point 310 in the first tile and with an end point 315 in the second tile.

Although FIG. 3 shows the touch-screen 110 as a flat rectangle overlaid on a flat, rectangular electronic display 115, alternate embodiments may include configurations such as, but not limited to, having the touch-screen 110 in a separate location from the electronic display 115 as, for instance, in having a real-time touch screen on a surface and wirelessly connected to a display that may, for instance, be an image projected on a screen, or having a real-time touch screen that is three dimensional such as, but not limited to, a sphere, a hemisphere, a tetrahedron, or some other shape and where the screen may have a similar physical shape with the real-time touch screen attached or remote, or some combination thereof.

Similarly, although the tiles 120 are shown in FIG. 3 as a rectangle, they may assume a number of shapes. In a preferred embodiment, the tiles 120 may be any suitable shape or shapes that tessellate the surface, i.e., cover the surface fully as this may make maximum use of the pixels of a fully populated surface. The tiles may all be the same shape such as, but not limited to, a triangle, a square, a rectangle or a hexagon for a flat surface. The tiles may also be a combination of two or more shapes such as, but not limited to, a combination of octagons and squares.

In such a system, it may be possible to create signal vectors having vector-dimensions that may include the gesture used to produce an action, as well as associated relevant data such as, but not limited to, the type of content being transferred, the length and speed of the gesture initiating the transfer, the time the gesture was made, the location of the devices used to make the gesture, data identifying the user and/or the user's location and data identifying the source of the content, or some combination thereof.

Based on one or more elements of the signal-vector, an appropriate, or targeted, message or advertisement may be delivered to the electronic display 115. The ad may, for instance, be delivered based on the subject type 180 of the transferred content element.

The advertising element 175 may be delivered to the same tile to which the content has been transferred or may be delivered to a nearby tile that may currently have no content being delivered.

In a further preferred embodiment of the invention, creating a signal-vector may also include creating a category-vector 320 (see FIG. 5) that may be representative of the trend. The category-vector 320 may, for instance, be made up of a subset of the vector-dimensions of the signal-vector that may include elements, or dimensions, such as, but not limited to, the type of content being transferred, the length and speed of the gesture initiating the transfer, the time the gesture was made, the location of the devices used to make the gesture, data identifying the user, and data identifying the source of the content, or some combination thereof, expressed as numerical values in a vector form.

In a further preferred embodiment of the invention, creating a signal-vector may also include defining a weighting tensor. The weighting tensor may, for instance, be made up of the vector-dimensions of the signal-vector and may include dimensions that represent one or more of the measurable attributes described above. The weighting tensor may for instance have vector-dimensions that may represent the length and velocity of the gesture, arranged as weighting factors such that a combining the category vector and the weighting tensor may create a transaction value 345 (see FIG. 5).

The weighting may also depend on the type of interaction. A tap may, for instance, be weighted less than a gesture that may be a tap, a touch and a swipe, especially if the intention of the gesture was to move an object, or part of an object, such as, but not limited to an image, a video or specific text, or some combination thereof, from one location to another.

For instance, the category vector 320 may be represented as a one dimensional vector:

CV=(a,b,c,d) (1)

where a, b, c and d may each be one element of the associated relevant data identified above, represented in a suitable numerical value that may, for instance, be a value such as, but not limited to, a category rank, an absolute value, a percentage or fraction of an average, a maximum or a minimum value or some combination thereof.

The weighting tensor may, for instance, be a one dimensional tensor, represented mathematically as:

$$WT = ( \begin{matrix}e \\ f \\ g \\ h\end{matrix} )$$

where e, f, g and h may be coefficients that may depend on measurable aspects of the data associated with the captured transaction 170 such as, but not limited to, the length of the touch gesture or velocity of said touch gesture, or some combination thereof.

The product of the category vector 320 and the weighting tensor may, for instance, be expressed as:

$$\begin{matrix}TV = CV \times WT \\ = ( a , b , c , d ) \times ( \begin{matrix}e \\ f \\ g \\ h\end{matrix} ) \\ = ( a . e + b . f + c . g + d . h ) \\ = the transaction value 345.\end{matrix}$$

Other components that may be dimensions of a vector or a tensor include, but are not limited to, intensity, transaction, referencing, reach, spread, stickiness, derivatives, pathways and channels of signaling, time, duration, speed, acceleration, valuation, prediction, projections, trend influences, trend generation, tend intervention, all of which may be obtained using techniques such as heat mapping and pattern resolving methods.

FIG. 4 shows a schematic of a touch-screen operated interface in accordance with the present invention.

A touch-screen 110 and an electronic display 115 may both be controlled by an operating system 135. The connections between the device may be wired or wireless. Preferably the touch-screen 110 and the electronic display 115 are congruent, i.e., they may have the same geometrical structure but may be larger or smaller, and this may occur whether they are 2 dimensional objects or three dimension objects. Being congruent may make for easier use as individual locations on the touch-screen 110 may then correspond to individual locations on the electronic display 115, or the graphic user interface 105 displayed on the electronic display 115. This correspondence may make the control system more intuitive to use.

The touch-screen 110 and the electronic display 115 may overlap, but need not do so. In a further preferred embodiment of the invention, the touch-screen 110 and the electronic display 115 are separated, with the touch-screen 110 being sized so that a human operator may easily reach all the parts of the touch-screen, while the graphic user interface 105 displayed on, or by, the electronic display 115 may be a larger, congruent version of the real-time touch screen, sized to be easily viewed by, for instance, an audience such as, but not limited to, a group of people in a conference room, students in a class room or lecture theater, or a gathering of people at a theater or at a stadium.

FIG. 4 also shows tiles 120 that may be displayed on, or along with, the graphic user interface 105 by the electronic display 115 that may be under the control of the operating system 135 operable on a suitably powerful computer 370.

As detailed above, although shown as rectangles, the tiles may be any shape, but in a preferred embodiment they may be of individual, or groups of, shapes that tessellate the graphic user interface 105 and/or the pixels of the electronic display 115. Suitable tessellating shapes include, but are not limited to, triangles, squares, rectangles, hexagons, octagons and squares, non-regular polygons or some combination thereof. By tessellating the graphic user interface 105 and/or the pixels of the electronic display 115, the tiles may make optimal use of the pixels.

Each of the tiles 120 may, for instance, show content relayed from a specific source 130 via a network 375. The network 375 may be any suitable digital communications network such as, but not limited to, the Internet, a cable service, or some combination thereof. The network 375 may transport data by metallic wire, fiber optics, wireless electromagnetic radiation including infra-red, or some combination thereof.

FIG. 4 also shows the operating system 135 connected to a module auctioning a category-vector associated advertising-opportunity 350. Auctioning advertising to be associated with web content is a well-known technique in the art of web based advertising. The auctioning of opportunities may be done in advance, or in real time. The ad opportunities are, however, typically categorized by keywords that as text in the content.

In a preferred embodiment of the present invention, categorization of ad opportunities may also or instead be based on category vectors, or transaction values. Using category vector 320 or transaction values 345 as part or as all of the basis for making advertising opportunities available may, for instance, allow advertisers to fine tune their targeting on real-time touch screen based displays. By observing category vector 320 and transaction values 345 and discerning patterns of behavior correlated or associated with the patterns, advertisers may be able to target users with greater precision or efficacy. Certain patterns of behavior may, for instance, be indicate that a user is in a mind frame to buy a particular product as soon as they find something suitable, and that may be an optimal time to advertise. On the other hand, user behavior may indicate that they are merely browsing for fun with no immediate intent of buying and that may indicate a less optimal time to advertise.

In auctioning, there may be many strategies associated with effective bidding. In a preferred embodiment of the present invention, a minimum transaction value may be specified for a particular category-vector associated advertising-opportunity 350. This may, for instance, eliminate non-serious bidders and simplify or streamline the decision process for the auctioning module, a factor that may be of great importance in a real time bidding situation, i.e., where the opportunity being bid on is currently occurring on the users communication device, and the ad of the successful bidder has to be delivered in a time frame that appears seamless to the user.

FIG. 5 shows a schematic of a graphic display of the present invention. The graphic display 360 in FIG. 5 shows the transaction value 345 plotted as a function of time for a number of web-site type 305 or category vectors 320. Graphing how the transaction value 345 varies with time may, for instance, result in discerning predictive patterns 365 that may be indicative of trends such as, but not limited to, user behavior, in particular of user behavior regarding purchasing product.

For example, by observing the transaction values obtained from on a website, or an advertising website, related to a restaurant business, may reveal, that ads displayed between 5 am -10 pm lead to most coupons leading to eating at that restaurant either for lunch or dinner, while adds displayed after 4 pm are much more likely to lead to the associated coupons being saved for another day.

Recording, observing and understanding the underlying causes of such trends may be of significant value to store owners and merchants advertising on such systems.

FIG. 4 shows a graph of a number of transactions captured over a range defining a number of both category vectors and of weighting tensors. This combination of a number of transactions, category vectors and weighting tensors may be combined to form a graphic display 360, as shown in FIG. 4.

This graphic display 360 may then be analyzed to discern, or to generate, a predictive pattern 365 that may be indicative of a trend related to, for instance, the web-site type 305 or the category vector 320 or some combination thereof.

Other attributes or parameters that may be used include, but are not limited to, the length of time or duration that the user spends on a particular object, or stays within a certain subject or category or some combination thereof. These may, for instance, be used to create a “heat map” by having the visual intensity of a visual map or network be related to the length of time by, for instance a projected linear relationship. Such a heat map may allow further analysis for purposes such as, but not limited to, trend definition.

Another parameter of use may for instance be the ratio of repeat visits to an element of content as a function of how often that element is changed. A content element, such as a piece of news, that is only changed at a low frequency, but which attracts a large number of repeat visits or accesses may be recorded as a high referencing score. A high referencing score may mean that there is a large chance that the news element may be referenced by the user, and therefore there is a large chance of a new signal being generated that may be considered as a derivative score of the original signal.

A simple form of mathematical explanation for the rate of signaling may be similar to that of the following intracellular signally pathway differential equation:

$$\frac{d 〚 {[ Ca 〛}^{2 +} ]}{d t} = λ {1}_{Ca} + {k}_{exch} ( [ {Ca}_{ER}^{2 +} ] \pm [ {Ca}_{cyt}^{2 +} ] ) \pm {k}_{Ca} [ {Ca}_{cyt}^{2 +} ] \qquad ( 1 )$$

Where Ca²⁺ represents the cytoplasmic calcium

I_{Ca} represents the calcium current;
λ is a scaling constant to convert current to a rates of change of concentration;

λI_{Ca} describes calcium flux through an ion channel or set of ion channels:

The second term on the right hand side describes calcium exchange between the endoplasmic reticulum (ER) and the cytoplasm.

Whereas, Ca2+ is the signal in discussion in equation 1, the formula describes the signal influx through a channel or set of channels, which in our case the channels may be various media platforms, sharing platforms and interactions between users. When creating detailed expressions of the signaling currents, parameters such as the “referencing score” (as described in the previous email) or other catalytic parameters may be used in place to express the voltage/time dependency.

Although the invention has been described largely in terms of 2-D real-time touch screens, one of ordinary skill in the art will, however, appreciate that the methods of the invention may also be applied to 3-D input devices such as, but not limited to, 3-D real-time touch screens, 3-D gesture capture device, 3-D environments for display and input capture using a plurality of 2-D devices, or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of analyzing a trend, comprising:
receiving a signal created on a network-connected touch-screen by actively filtering content relating to one of an event, a person or a product, or some combination thereof;
creating a signal-vector by mapping said signal to two or more vector-dimensions, one of said vector-dimensions being an origination location of said signal;
repeating said creating a vector for a plurality of said signals; and
defining said trend as a cluster of said signal-vectors having a cluster size that exceeds a predetermined threshold.

2. The method of claim 1 further comprising influencing said trend by delivering an influence-module to at least one originating location contained within said trend.

3. The method of claim 1 wherein said vector-dimensions further comprise an occurrence time and a filter category.

4. The method of claim 1 further comprising associating a trend velocity to said trend, said trend velocity being a rate of change of the cluster size of said trend as a function of time.

5. The method of claim 4 further comprising associating a trend acceleration with said trend, said acceleration being a rate of change of said trend velocity with time.

6. The method of claim 1 wherein said actively filtering content further comprises performing a touch gesture related to a representation of content from a specific source.

7. The method of claim 2 wherein said influence module comprises an advertising element related to a product or a service.

8. The method of claim 7 further comprising providing a graphic user interface, said graphic user interface comprising;
said touch-screen;
an electronic display displaying at least two tiles, each of said tiles being a representation of the content from a specific source; and
wherein actively filtering content further comprises transferring a content element from a first tile to a second tile.

9. The method of claim 8 wherein said graphic interface is controlled, in part, by an operating system programmed to transfer said content element from said first tile to said second tile when activated to do so by an appropriate touch gesture that is indicative of a transfer path between said first and second tiles and includes a user contact with a start point in said first tile and with an end point in said second tile.

10. The method of claim 9 wherein said vector-dimensions further comprise an identified subject type of said content element.

11. The method of claim 10 wherein said vector-dimensions further comprise a web-site type for each of said tiles, and said start point and said end point of said touch gesture.

12. The method of claim 11 wherein said vector-dimensions further comprise a length and a velocity of said touch gesture.

13. The method of claim 11 further comprises creating a category-vector using a first subset of said vector-dimensions and a weighting-tensor using a second subset of said vector-dimensions, and wherein combining said category-vector and said weighting-tensor creates a transaction-value.

14. The method of claim 13 wherein said category-vector subset of vector-dimensions comprises said occurrence time, said filter category and said originating location, and wherein said weighting-tensor subset of vector-dimensions comprises said length and said velocity of said touch gesture.

15. The method of claim 13 further comprising auctioning a category-vector associated advertising-opportunity.

16. The method of claim 15 wherein said auctioning further comprises specifying a minimum transaction value for a use of said category-vector associated advertising opportunity.

17. The method of claim 13 further comprises creating a plurality of said category-vectors and a plurality of said weighting tensors, and wherein said plurality of category-vectors and weighting-tensors are combined to form a graphic display.

18. The method of claim 7 wherein said graphic display is analyzed to generate a predictive pattern.

19. The method of claim 18 wherein said predictive pattern further comprises a heat-map.

20. The method of claim 19 wherein said heat-map comprises a real-time psychometric measurement of attitudes towards said trend.
